(19) United States
(12) Patent Application Publication
(10) Pub. No.: US 2013/0051253 A1
(43) Pub. Date: Feb. 28, 2013

(54) METHOD AND APPARATUS FOR IMPROVING USER EXPERIENCE VIA PAYLOAD ADAPTATION

(71) Applicants: James M. LIN, San Diego, CA (US); Karthika PALADUGU, San Diego, CA (US)

(72) Inventors: James M. LIN, San Diego, CA (US); Karthika PALADUGU, San Diego, CA (US)

(21) Appl. No.: 13/215,962

(22) Filed: Aug. 23, 2011

(51) Int. Cl. H04W 24/00

(52) U.S. Cl. 370/252

(57) ABSTRACT

Apparatus and methods for payload adaptation for a mobile device based on a request from the mobile device include determining a communication connection characteristic of the request and obtaining one or more results to generate obtained results responsive to the request. The apparatus and methods further include customizing the obtained results to generate customized results based on the communication connection characteristic and transmitting the customized results to the mobile device.

### BACKGROUND

The described aspects relate to wireless communications, and more particularly, to a method and apparatus for adapting payloads of a protocol based on a physical layer origin server in order to provide a responsive user experience.

Wireless communication networks are used for a diverse number of applications in addition to carrying voice traffic. For example, data may be carried to implement a content download system between mobile devices and the network. International Mobile Telecommunications Multi-Carrier (IMT-MC), is a family of 3rd Generation (3G) mobile technology standards that use code division multiple access (CDMA) to send voice, data, and signaling data between mobile phones and cell sites. The set of standards includes: CDMA2000 1× (1×), CDMA2000 Evolution-Data Optimized (EV-DO) Rev. 0, CDMA2000 EV-DO Rev. A, and CDMA2000 EV-DO Rev. B. All of these standards are approved radio interfaces for IMT-2000. CDMA2000 has a relatively long technical history and is backward-compatible with its previous 2nd Generation (2G) iteration Interim Standard 95 (IS-95) (cdmaOne). The successor to CDMA2000 is Long Term Evolution (LTE), part of the competing 3rd Generation Partnership Project (3GPP) family. LTE includes LTE/IMT-Advanced, which is an enhanced version of LTE that is considered to be a true 4th Generation (4G) system.

In a content download system that serves many types of mobile devices associated with various network operators over a plurality of different communication connections, often times content offered for download is not able to be efficiently downloaded to a device. In other words, large or high-memory-use content may take a long time to download over relatively slower networks, thereby providing a user of the device with an unsatisfactory user experience. For example, an application layer protocol targeted for 3G networks as described above may contain information that may be unnecessary for all cases. When the target network for the protocol is 1×, a user will experience less than optimal performance. Thus, if a search on that protocol is normally expected to return 25 results, returning that response on the 3G network may be 5 seconds whereas returning the same 25 results on the 1× network may be 12 seconds.

Thus, it would be desirable to adapt the operation of content download systems based on payload adaptation to provide improved user experience.

### SUMMARY

The following presents a simplified summary of one or more aspects of a method and apparatus for improving user experience via payload adaptation in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method for payload adaptation for a mobile device based on a request from the mobile device includes determining a communication connection characteristic of the request. The method further includes obtaining one or more results to generate obtained results responsive to the request and customizing the obtained results to generate customized results based on the communication connection characteristic. The method further includes and transmitting the customized results to the mobile device.

In another aspect, an apparatus for payload adaptation for a mobile device based on a request from the mobile device includes means for determining a communication connection characteristic of the request. The apparatus further includes means for obtaining one or more results to generate obtained results responsive to the request and means for customizing the obtained results to generate customized results based on the communication connection characteristic. The method further includes means for transmitting the customized results to the mobile device.

In another aspect, a computer program product for payload adaptation for a mobile device based on a request from the mobile device includes a computer-readable medium. The computer-readable medium includes at least one instruction to cause a computer to determine a communication connection characteristic of the request and at least one instruction to cause the computer to obtain one or more results to generate obtained results responsive to the request. The computer-readable medium further includes at least one instruction to cause the computer to customize the obtained results to generate customized results based on the communication connection characteristic, and at least one instruction to cause the computer to transmit the customized results to the mobile device.

In still another aspect, an apparatus for payload adaptation for a mobile device based on a request from the mobile device includes a processor and a memory coupled to the processor. The memory is configured to cause the processor to determine a communication connection characteristic of the request, obtain one or more results to generate obtained results responsive to the request, customize the obtained results to generate customized results based on the communication connection characteristic, and transmit the customized results to the mobile device.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of a content delivery system in a network with mixed-communication technologies and payload adaptation for a plurality of wireless devices, according to one aspect;

FIG. 2 is a message flow diagram illustrating an example of a payload adaptation approach that may be used in the network of FIG. 1, according to one aspect;

FIG. 3 is a message flow diagram illustrating an example of a second payload adaptation approach that may be used in the network of FIG. 1, according to one aspect;

FIG. 4 is a diagram of a user interface illustrating an example of a full set of results returned from a request from one wireless device in the plurality of wireless devices, according to one aspect;

FIG. 5 is a diagram of a user interface illustrating an example of a reduced set of results returned from a request from another wireless device in the plurality of wireless devices, according to one aspect;

FIG. 6 is a diagram of a user interface illustrating an example of a partial set of results returned from a request from yet another wireless device in the plurality of wireless devices, according to one aspect;

FIG. 7 is a block diagram illustrating a signal flow in the content delivery system using a communications system model, according to one aspect;

FIG. 8 is a flow diagram illustrating an operation of the payload adaptation approach that may be used in the network of FIG. 1, according to one aspect;

FIG. 9 is a block diagram illustrating an example of a wireless node, according to one aspect;

FIG. 10 is a block diagram of an apparatus that includes a processing system that may be used to implement a mobile device in the network of FIG. 1, according to one aspect;

FIG. 11 is a block diagram of an apparatus that includes a processing system that may be used to implement a server in the network of FIG. 1, according to one aspect;

FIG. 12 is a block diagram of a generic apparatus that may be used to implement a server or a mobile device in the network of FIG. 1, according to one aspect.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosed system are described more fully hereinafter with reference to the accompanying drawings. The disclosed system may, however, be configured in many different forms and should not be construed as limited to any specific structure or function presented throughout this disclosure. Rather, these aspects are provided so that this disclosure will be thorough and complete, and will convey the scope of the system to those skilled in the art in detail. Based on the teachings herein, one skilled in the art should appreciate that the scope of the system is intended to cover any aspect of the system disclosed herein, whether implemented independently of or combined with any other aspect of the system. For example, an apparatus may be implemented or a method may be practiced using any number of the aspects set forth herein. In addition, the scope of the system is intended to cover such an apparatus or method that is practiced using other structure, functionality, or structure and functionality in addition to or other than the various aspects of the system set forth herein. It should be understood that any aspect of the system disclosed herein may be read on by one or more elements of a claim.

In the various aspects of payload adaptation in the form of content download protocol optimization described herein, content composition for a user is constructed based on one or more communication connection characteristics of the user's device, including dynamically modifying the content composition to account for changing communication characteristics that may occur based on movement of the wireless device. In one aspect, a component determines a current communication connection characteristic of the wireless device associated with a received request for content. For example, the component may determine one or more of a bandwidth or physical layer characteristic, a country or Mobile Country Code (MCC), a network operator or Mobile Network Code (MNC), or any other characteristics associated with the communication connection. As further described herein, in one aspect, payload adaptation for a query sent to a mobile store server may be based on a connection-type header approach, or on origin tracing.

One benefit to the disclosed approaches is that the content adaptation would make the user experience more responsive for slower devices. The user experience responsiveness would be relatively consistent independent of the physical layer and the tradeoff for doing the trace would be much less than gain from trying to send less data. Additionally, this approach does not tie protocol responses to the physical layer that is used to establish the session initially (which is the common approach). A user that starts in 1× and moves to Wi-Fi could have the experience adjusted dynamically, and the user on Wi-Fi that goes to 1× would not have a really bad experience with load times. Further, although existing solutions may revolve around some configuration setting that is sent with every request (streaming video setting the connection speed) or the client communicating the connection in some way, the disclosed approach utilizes the server to do the detection and tailor to the client so that the client does not need to adapt to the change and may be oblivious.

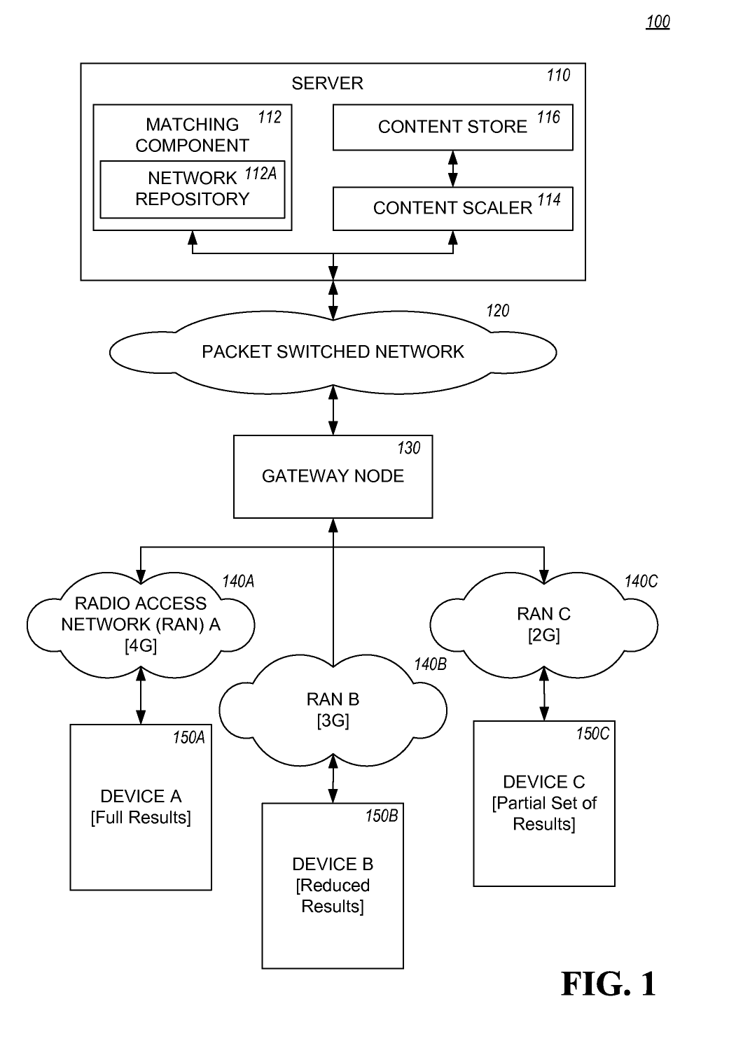

FIG. 1 illustrates a network 100 in which the various aspects of the disclosed system may be implemented, according to one aspect. A plurality of access terminals such as a plurality of wireless devices 150A, 150B, and 150C accesses a server 110 through a respective Radio Access Network (RAN) A 140A, RAN B 140B, and RAN C 140C via one or more access points associated with the RANs (not shown). In one aspect, the RANs may be a CDMA2000 mobile network. The RANs may also encompass Global System for Mobile Communications (GSM)/Universal Mobile Telecommunications System (UMTS) or LTE networks. The RANs may support any number of access points distributed throughout a geographic region to provide coverage for the plurality of wireless devices 150A, 150B, and 150C. As illustrated, the RAN 140A is a network operating with 4G performance, the RAN 140B is a network operating with 3G performance, and the RAN 140C is a network operating with 2G performance. In general, the plurality of wireless devices 150A, 150B, and 150C will be referred to as the wireless devices 150, and the respective RAN A 140A, RAN B 140B, and RAN C 140C will be referred to as the RAN 140.

In the description contained herein, the term “access point” is used to designate a transmitting node and the term “access terminal” is used to designate a receiving node for downlink communications, whereas the term “access point” is used to designate a receiving node and the term “access terminal” is used to designate a transmitting node for uplink communications. However, those skilled in the art will readily understand that other terminology or nomenclature may be used for an access point and/or access terminal By way of example, an access point may be referred to as a base station, a base transceiver station, a station, a terminal, a node, an access terminal acting as an access point, or some other suitable terminology. An access terminal may be referred to as a user terminal, a user device, a mobile station, a subscriber station, a station, a wireless device, a terminal, a node, or some other suitable terminology. An access terminal, which may be fixed or mobile, utilizes the backhaul services of an access point or engages in communications with other access terminals or access points. Examples of access terminals include a telephone (e.g., cellular telephone), a laptop computer, a desktop computer, a Personal Digital Assistant (PDA), a digital audio player (e.g., MP3 player), a camera, a game console, or any other suitable wireless node. The various concepts described throughout this disclosure are intended to apply to all suitable wireless nodes regardless of their specific nomenclature. For example, access terminals refer to wireless devices 150A, 150B, and 150C.

Through the use of a gateway node 130, each one of the RANs 140A, 140B, and 140C is coupled to a packet switched network 120 such as the Internet so that communications to the server 110 may be established through the packet switched network 120. In one aspect, the gateway node 130 may be a Packet Data Service Node (PDSN), which is a component of a CDMA2000 mobile network that acts as the connection point between radio access networks such as the RANs and IP networks such as the packet switched network 120. In another aspect, the gateway node 130 may be implemented using a General Packet Radio Service (GPRS) Gateway Support Node (GGSN) for a GSM/UMTS network. In another aspect, the gateway node 130 may be a PDN-GW for an LTE packet data network. This gateway node 130 is responsible for managing sessions such as Point-to-Point Protocol (PPP) sessions between the mobile provider's core IP network and mobile stations. For example, the gateway node 130 provides both mobility management functions and packet routing functionality.

To simplify the illustration of the network 100, only one generalized representation of most components is illustrated in FIG. 1. However, it should apparent that each component may exist in multiples. For example, as described herein, the RANs encompass multiple types of radio access technologies such as CDMA2000 and LTE. The description also envisions use of multiple iterations of the same component. For example, each of the RANs may encompass multiple CDMA2000 networks.

Continuing to refer to FIG. 1, the server 110 includes a matching component 112 and a content scaler 114, which together provides the various payload adaption mechanisms described herein. A content store 116, which in this example is a repository of content, is also included in server 110. Although depicted as being a part of the server 110, it is to be appreciated that the matching component 112, the content scaler 114, and the content store 116 may be implemented as part of one or more servers. In one aspect of the disclosed system, the server 110 is used to implement a shopping experience that offers applications and other content for use on a mobile device such as the plurality of wireless devices 150A, 150B, and 150C. As an example of an operation of the content distribution application for which the network 100 may be used, a user using wireless device 150A will transmit a request searching the available content from the server 110. In response, the server 110 will perform a search in the content store 116 using the content scaler 114 based on the request that returns a list of applicable content. As used in this disclosure, the term “content” includes, at least, any type of application, multimedia file, image file, executable program, web page, script, document, presentation, message, data, meta-data, or any other type of media or information that may be rendered, processed, or executed on a device.

The list of applicable content may include an identification of a set of applications, along with their respective descriptions and metadata, that satisfies the user's request. The descriptions may include images such as thumbnails, videos, or other multimedia content. As noted herein, one issue with trying to transmit the results is that the particular wireless device may not be able to efficiently receive the transmission. The content scaler 114 will operate to process the list to create a payload before transmitting it to the requesting device. In one aspect of the operation of content delivery, the payload of the transmission is adapted based on the connection characteristics of the wireless device submitting the request before content is transmitted. For example, the device A 150A, which is coupled to the RAN A 140A—a high speed network, will be sent the full set of results. The device B 150B, which is coupled to the RAN B 140B—a lower speed network, will be sent the same set of results, but one that is reduced in size, as further described below. The device C 150C, which is coupled to the RAN C 140C—the lowest speed network in the example, will be sent a partial set of results.

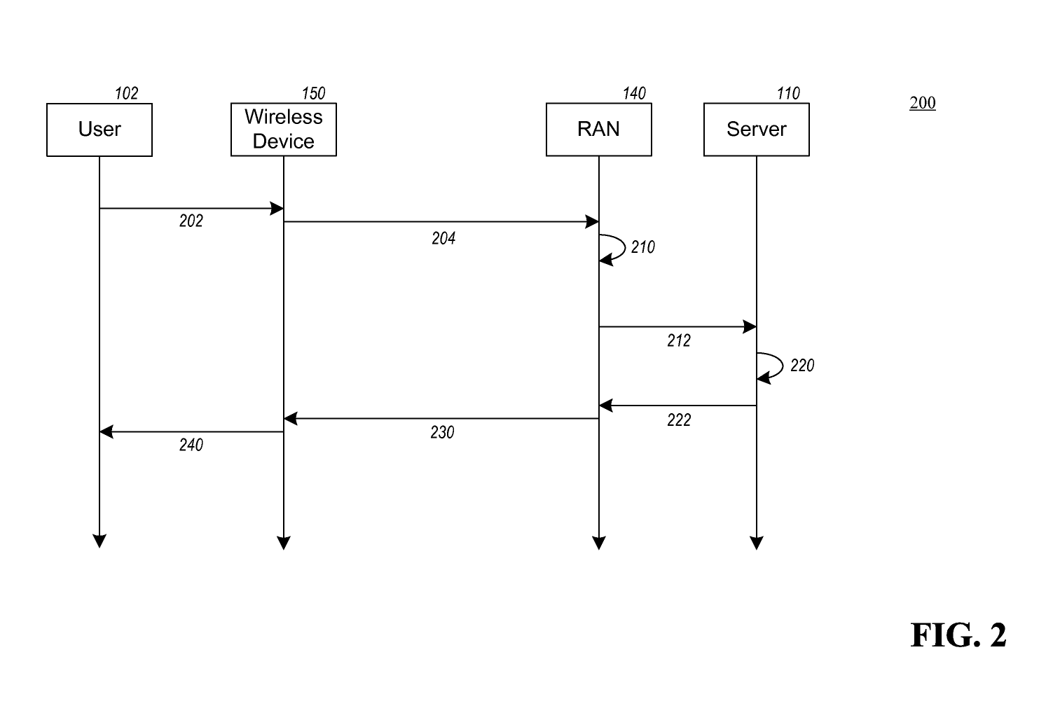

FIG. 2 illustrates a call flow process 200, where a user 102 initiates a request such as a search at 202 through the use of a mobile store app on a wireless device 150 such as one of the wireless devices 150A, 150B, and 150C. At 204, the mobile store app will transmit a search query to a RAN 140 such as one of the RANs 140A, 140B, and 140C that is associated with the wireless device 150 to forward to the server 110.

As described above, the RAN 140 will include a gateway node to communicate with the server 110 via the packet switched network 120. In one aspect, gateway nodes in any 2G/3G/4G network, such as the gateway node 130 of the RAN 140, may be configured with a list of IP addresses for a specific group of application servers (or potentially any app server), such as server 110. Also, the packets are marked to indicate the type of network from which the packet was sent. In one implementation, the Differentiated Services Code Point (DSCP) field may be used for marking the IP packets routed to these servers. The DSCP is a 6-bit field in headers of IP packets that may be used for packet classification purposes.

At 210, continuing with the example of using DSCP, the gateway node 130 will mark the outer IP header for IP packets to be routed to the destination server IP address, such as the IP address for the server 110, with the specific DSCP value to indicate the type of network to which the wireless device is connected. The information will generally be referred to herein as a connection type header. This operation will happen essentially for an initial context request or any traffic sent to the server 110, and the server 110 may from then on use the particular network type to scale the content. It should be noted that by using the gateway node 130 to mark the packet, the wireless device 150 may be relieved of this procedure and allow easier and cheaper development of the wireless device 150 because it may be agnostic of the protocol details.

Different air interface technology networks may have different DSCP values. For example, where RAN 140 is a 3G EV-DO network, the gateway node 130 is a PDSN and may be configured with IP address/DSCP values: DSCP_a. Where RAN 140 is a 1× network, the gateway node 130 is a PDSN and may be configured with IP address/DSCP values: DSCP b. In some cases, both the EV-DO and 1× networks share the same PDSN, which acts as the connection point between the radio access and IP networks. In that case, the PDSN should identify that it is connected to the 1× or EV-DO network and use the appropriate DSCP. Where the RAN 140 is a WCDMA network such as WCDMA Release 6, the gateway node 130 is a GGSN and may be configured with IP address/DSCP values: DSCP_c. Finally, where the RAN 140 is an LTE network, the gateway node 130 is a P-GW and may be configured with IP address/DSCP values: DSCP_d. The content scaler 112 is configured with these DSCP values and the type of network information, such as data rate or bandwidth supported on the networks based on DSCP. For example, where DSCP_d>DSCP_c/DSCP_a>DSCP_b, this configuration may be used to scale the content appropriately.

Once the connection type header has been added at 210, at 212 the request will be forwarded to the server 110 through the packet switched network 120. The server 110 will perform a query on the content store 116 through the content scaler 114 to obtain one or more obtained results, the obtained results of which will be modified or customized based on the connection type header.

At 220, the content scaler 114 alters, or customizes, a composition of the requested content based on the determined communication connection characteristic. In various aspects of the content scaling, for a relatively slow communication connection, e.g. a 1× connection as compared to a Wi-Fi connection, the content scaler 114 may remove portions of the requested content (e.g., remove a relatively large image portion) and/or alter the content composition (e.g., reduce the size of the content), in order to enable faster delivery of the content over the detected, relatively slower communication connection. As a general example of removing a portion of the returned content, in the example for a 3G network, a search may be expected to return 25 results. However, returning 25 results on the 3G network could have had a response time of 5 seconds whereas the same 25 results on the 1× network may have been 12 seconds. To maintain the 5 second response time, only 10 results may be returned based on the search and still maintain a responsive user experience.

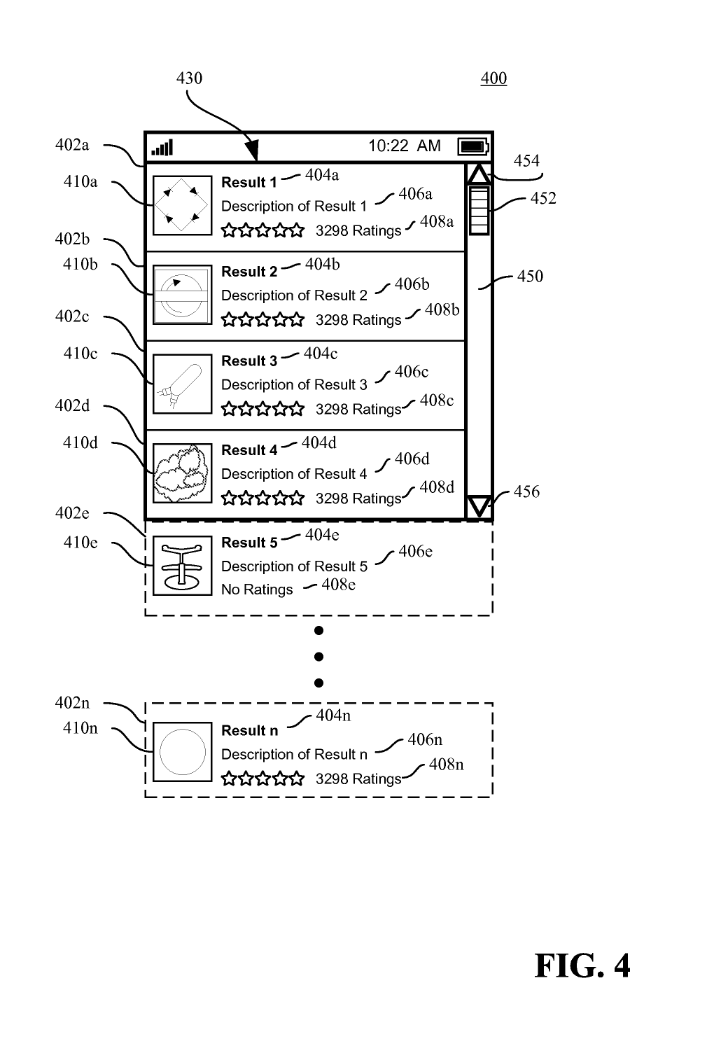

Referring back to FIG. 1 and further referring to FIG. 4, it may be seen that a full set of results 402a-402n that is obtained can be returned on the device A 150A on the RAN A 140A because the network supports 4G coverage. As illustrated on a user interface 400, the full set of results 402a-402n is returned, with results 402a-402d being displayed in a listing 430. The user may scroll through the full set of results 402a-402n using a scroll bar 450 that includes a slider 452 and an up scroll arrow 454 and a down scroll arrow 456. Thus, the user may scroll to bring results 402e-402n into view. Each item in the set of results 402a-402n includes an icon such as a respective set of icons 410a-410n, which may be a generic icon if a custom icon is not available for that item. Each item may also include a title such as a respective set of titles 404a-404n along with meta data that may be adapted to the device. As illustrated in the example, the metadata may include a description such as a respective set of descriptions 406a-406n. Further, the metadata for each item may also include a rating such as a respective set of ratings 408a-408n. As illustrated, each rating in the set of ratings 408a-408n includes a graphic illustrating the number of “stars” the associated item has been rated. The graphics for a star, as well as graphics for any generic pictures, such as icons, may be stored locally on the mobile device and/or transmitted only once but used over and over.

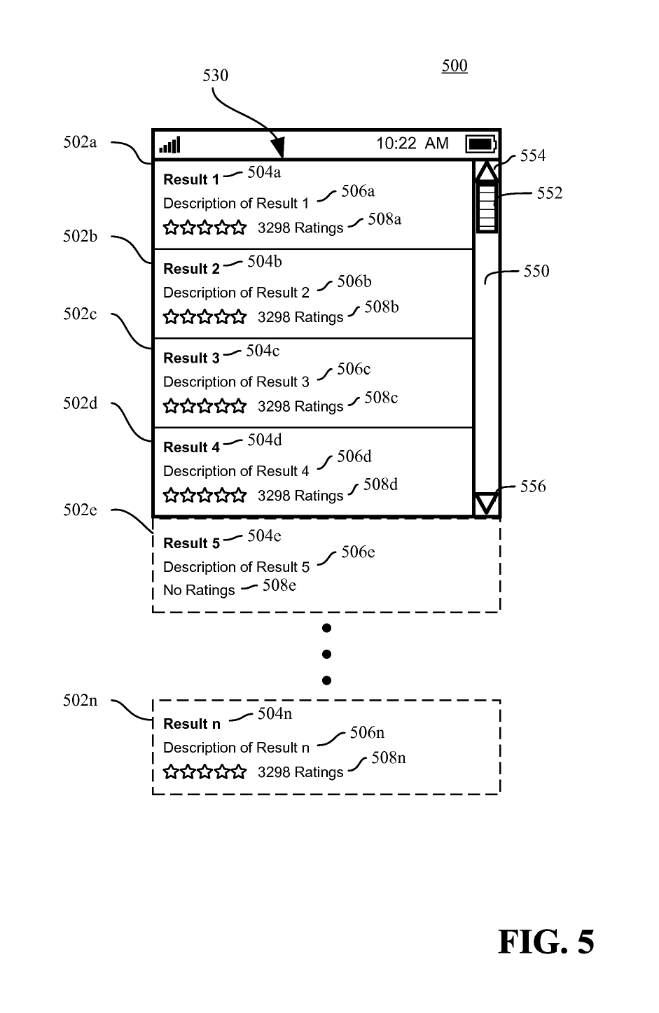

Further, the device B 150B on the RAN B 140B will be sent a reduced set of results because the RAN B 140B does not have as high of a throughput as the RAN A 140A. In one aspect of the approaches disclosed herein, the reduction of the set of results that was obtained may be such that one or more portions of each result in the full set of results are altered or removed. For example, referring to FIG. 5, each item in a set of results 502a-502n returned to the device B 150B will include a title such as one of an associated set of titles 504a-504n, a description such as one of an associated set of descriptions 506a-506n, and a rating such as one of an associated set of ratings 508a-508n. However, unlike the results for the device A 150A, which are returned with associated icons or thumbnails, images are omitted from the returned results to reduce the amount of bandwidth required to transmit the set of results 502a-502n. In another aspect of the approach described herein, instead of not transmitting the icon/thumbnail, a compressed or generic representation may be transmitted. As illustrated, items 502a-502d are displayed in a user interface 500, with the rest of the results 502e-502n being viewable using a scroll bar 550 that includes a slider 552 and an up scroll arrow 554 and a down scroll arrow 556.

As used herein, the term “altering” may encompass such operations as resampling files to remove redundant information, or perceptual coding. The term may also encompass such operations as lossless or lossy compression, which includes storing files in a format that is more efficient yet may require further processing to retrieve the information in the files. Generally, the term “altering” means any change to the original file format or combination with other files.

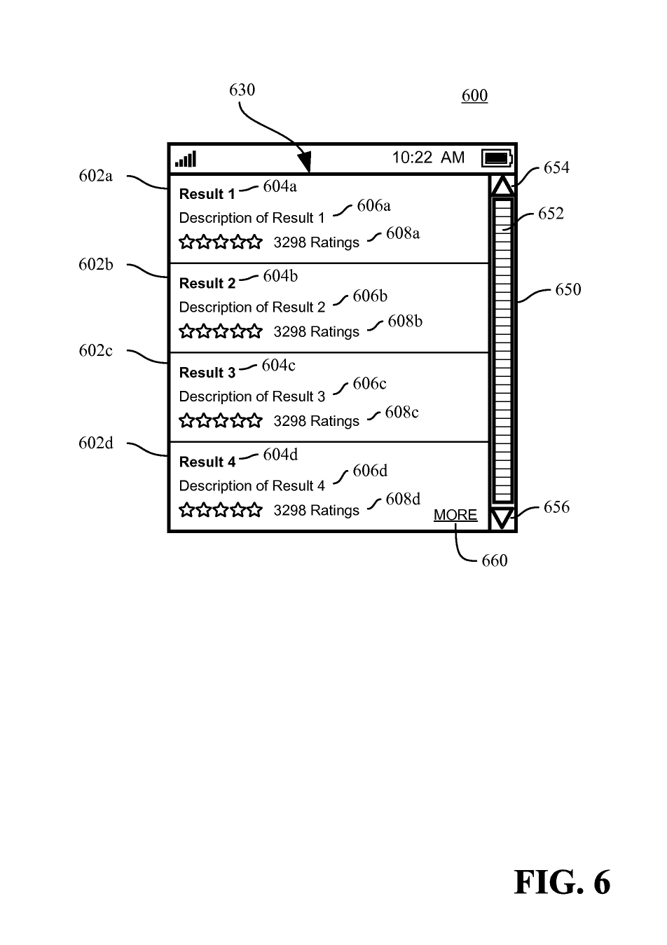

Further still, the RAN C 140C, being a lower throughput than the RAN A 140A and the RAN B 140B, will not be able to support the transmission of the full or reduced set of results as with the other RANs and ensure a particular response time. Thus, the device C 150C will only be sent a partial set of results that was obtained. For example, as illustrated in FIG. 6, the device C 150C will only be sent 4 results 602a-602d versus the full set of results that was sent to the device A 150A or the device B 150B. As illustrated, because all the returned items 602a-602d are displayed in the user interface 600, a scroll bar 650 that includes a slider 652 and an up scroll arrow 654 and a down scroll arrow 656 indicates to the user that all items are displayed. Where there are more results that have not been sent to the wireless device, a link 660 indicated as “MORE” may be used to retrieve further results. In another aspect, instead of a link, a user interface action such as trying to scroll off the viewable page in the user interface 600 using either the down scroll arrow 656 or scroll bar 650 will also retrieve further results.

It should be noted that as the wireless device may be mobile and move between different connection environments (e.g., the device may move between a 1× to 4G network), the matching component 112 and the content scaler 114 may operate to determine content composition based upon each specific request, thereby dynamically customizing content composition every time a response is sent based on the connection characteristics associated with each content request.

Once the results have been adapted, or customized, to the communication connection characteristic at 220 by the content scaler 114, the server 110 will return the search results at 222 to the RAN 140. The RAN 140 then transmits the search results at 230 to the mobile store app on the wireless device 150. The mobile store app will present the results to the user at 240.

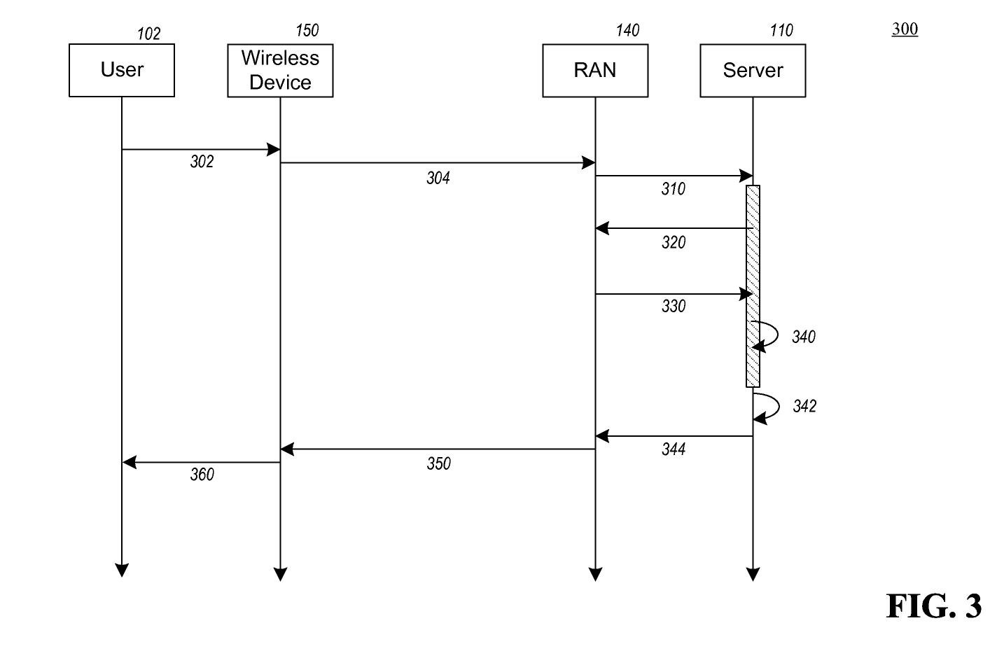

FIG. 3 illustrates a second call flow process 300 for implementing a payload adaptation process in accordance with a second approach based on origin of the wireless device that sent the request, where a user initiates a search at 302 through the use of the mobile application store on the wireless device 150. At 304, the mobile application app will transmit a search query to the RAN 140 to forward to the server 110. The RAN 140 will forward the request to the server 110 at 310. As discussed herein, the RAN 140 is coupled to the packet switched network 120 via the gateway node 130 so that the request from the wireless device 150 may be transmitted to the server 110.

Once the request has been received, the server 110 will perform a query on the content store 116 through the content scaler 114, the results of which will modified or customized based on the detected connection characteristics. In one aspect of the disclosed approach for detecting the connection characteristics of the wireless device 150, the matching component 112 of the server 110 will initiate a trace to recognize a list of well-known gateway nodes in a list of hops to the origin. In one aspect of the system, the IP address of the gateway nodes for each network is uniquely configured. To determine the connection characteristic, the matching component 112 of the server 110 may determine an origin of the content request at 320 to the RAN 140. The results are then sent back to the server 110 from the RAN 140 at 330. At 340, the matching component 112 may determine routing information associated with the request (e.g., network node information) from the routing results, and may access a network database 112A of network node information mapped to network characteristic information in order to find a match and determine the connection characteristics. In another approach, the trace may not be needed and a simple domain name service (DNS) lookup on the origin server may provide the necessary results.

At 342, the results are adapted, or customized, by the content scaler 114 based on the communication connection characteristics as described above at 220 of FIG. 2. Once the results have been adapted by the content scaler 114, the server 110 will return the search results at 344 to the RAN 140. The RAN 140 then transmits the search results at 350 to the mobile store app on the wireless device 150. The mobile store app will present the results to the user at 360.

In addition to the approaches described above, the matching component 112 may further determine a subscriber account characteristic, and the content scaler 114 may alter the content composition based thereon. For example, the content scaler 114 may reduce a size of content for a user having a subscription account characteristic that requires the user to pay based on a size/number of downloaded content, whereas the content scaler 114 may determine to not reduce a size of the same content for a different user having a subscriber account characteristic that allows unlimited size/number of downloads. Additionally, the content scaler 114 may dynamically alter content composition for a given user based on changes in subscriber account characteristics. For example, for a user having a download threshold (e.g., 50 MB per month), the content scaler 114 may reduce a size of a series of requested content over time as the accumulated downloads approach the download threshold.

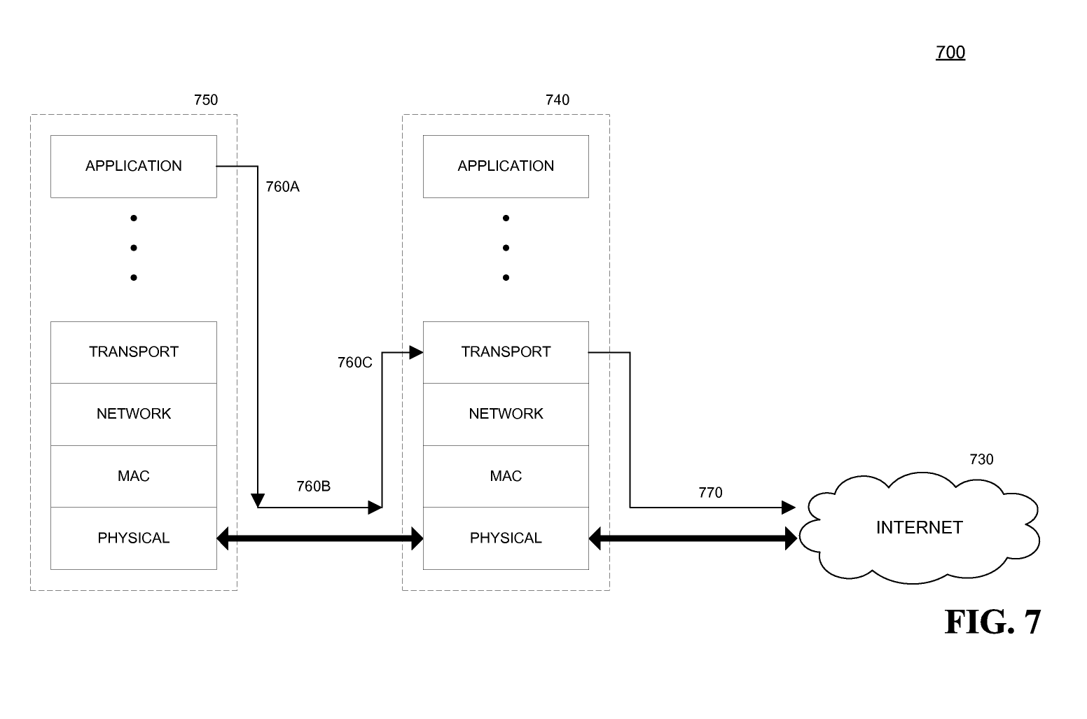

FIG. 7 illustrates a signal flow in the content delivery system using a communications system model 700 that includes a wireless stack 750 and a RAN stack 740. The illustration utilizes an Open Systems Interconnection model (OSI model) of the communication stacks. As illustrated, a request comes from an application layer of the wireless stack 750 and, as illustrated by a flow 760A, proceeds down through to a physical layer and is transmitted over a physical medium such as a wireless transmission 760B to the RAN stack 740.

At 760C, the RAN stack 740 receives the packet, unwraps the radio specific protocol headers for the packet, and aggregates them to form a single larger packet. When this larger packet is created 770A, the RAN adds the DSCP value (corresponding to the radio access channel used to connect the wireless device 750) before being sent to a packet-switched network such as Internet 730 in 770B. As discussed herein, by having the RAN apply the DSCP marking, or any form of marking that indicates the communication characteristics over which the packet has been sent, the wireless device is relieved of this burden and may be easier to implement.

In prior implementations, usually the wireless stack 750 marks the packet during 760A prior to being sent to the RAN 740. However it can be appreciated by one skilled in the art that in a wireless environment, the medium 760B in which the packet is sent can change for a mobile device as there are could potentially be roaming or signal degradation scenarios. If the application is not prepared to adjust to these issues, then the value supplied in 760A could be incorrect and impact the user of the wireless device 750 with a negative experience.

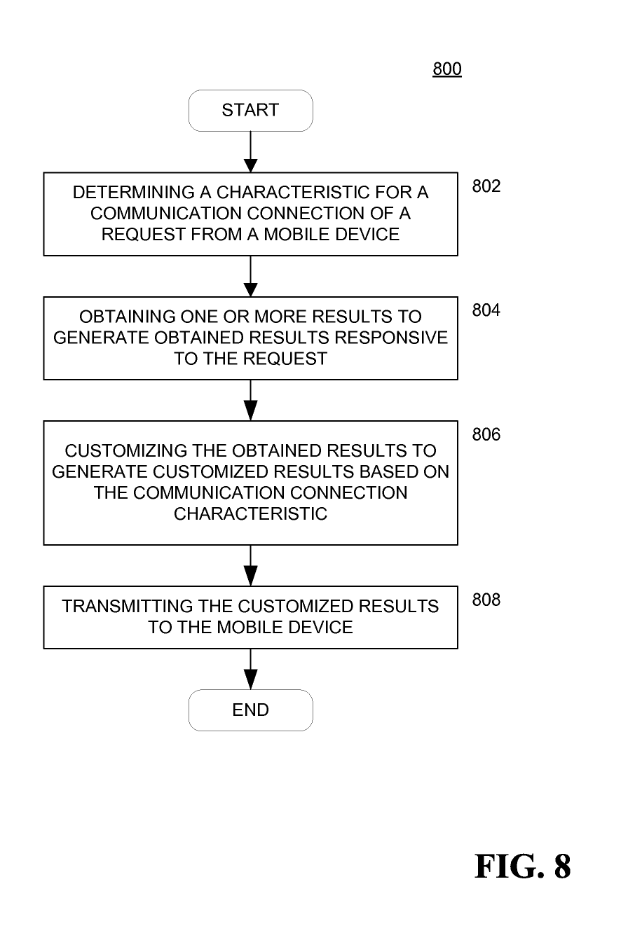

FIG. 8 illustrates a payload adaptation process 800 configured in accordance with one aspect of the disclosure where, at 802, the process 800 includes determining a characteristic for a communication connection of a request from a mobile device such as the wireless device. Then, at 804, obtaining one or more results to generate obtained results responsive to the request before customizing the obtained results to generate customized results based on the communication connection characteristic at 806. Finally, at 808, transmitting the customized results to the mobile device.

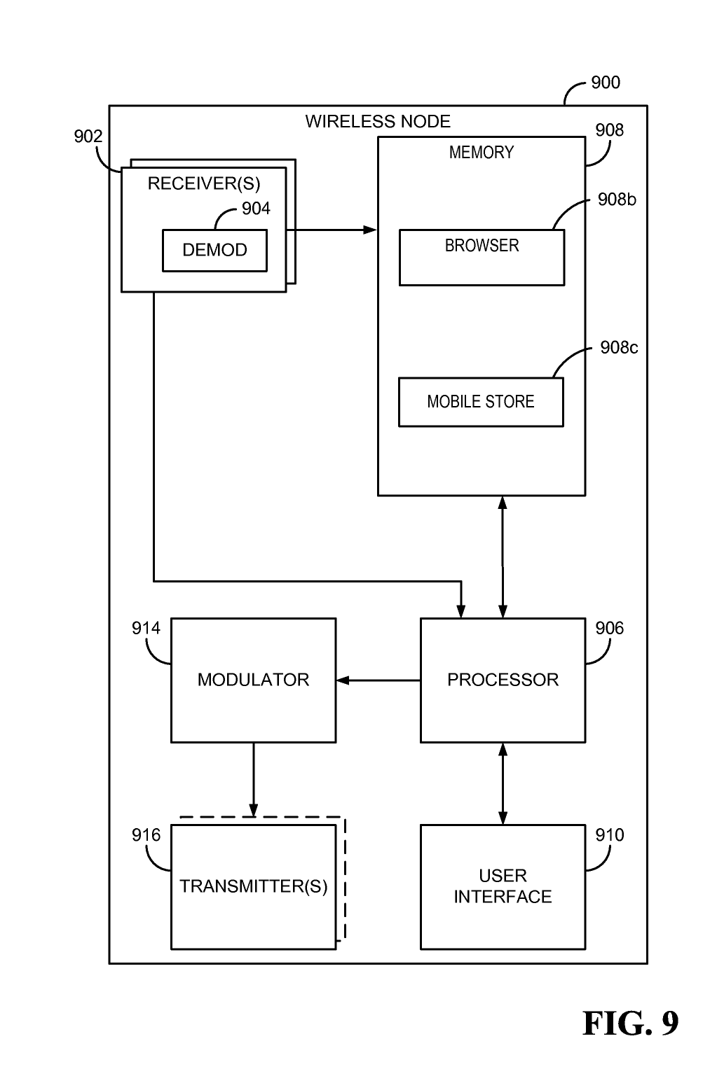

Referring to FIG. 9, in an aspect, a wireless node 900 that may be used to implement a user device such as the plurality of devices 150, 150B and 150C of FIG. 1 may include one or more receivers or a receiver system 902 that listens for and that may receive one or more signals from, for instance, one or more receive antennas (not shown), performs typical actions on (e.g., filters, amplifies, downconverts, etc.) the received signal(s), and digitizes the conditioned signal(s) to obtain samples. For example, in an aspect, receivers or receiver system 902 may include dual receivers, where a first receiver listens for and may receive communications from a first technology type network, and the second receiver listens for and may receive communications from a second technology type network, which is a different technology type than the first technology type network. For instance, the received communications may be pilot or control channel signals relating to establishing communication sessions with the respective networks, or the communication signals may be related to network discovery or acquisition.

The receivers 902 can each include a demodulator 904 that can demodulate received symbols and provide them to a processor 906 for channel estimation. The processor 906 can be a processor dedicated to analyzing information received by the receivers 902 and/or generating information for transmission by one or more transmitters 916, a processor that controls one or more components of the wireless node 900, and/or a processor that both analyzes information received by the receivers 902, generates information for transmission by the transmitters 916 after being modulated by a modulator 914, and controls one or more components of the wireless node 900. The processor 906 may also be configured to perform any necessary operation(s) to decode, reconstruct, or otherwise retrieve the results sent from the server 110.

The wireless node 900 may additionally include a memory 908 that is operatively coupled to the processor 906 and that can store data to be transmitted, data that is received, information related to active data network connections and any other suitable information for managing active data network connections and communicating via a communication channel. The memory 908 is also used to store instructions for a mobile store application (app) 908a. In an aspect, for example, the instructions stored in the memory 908 may be used to configure the processor 902 to establish and maintain one or more sessions to access the server 110 to implement a content distribution system, wherein a user may use the wireless node 900 to access the content and data stored on the server 110. The memory 908 may also contain instructions for other application such as a browser 908b that may also be used to access the server 110.

It will be appreciated that memory 908 described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 908 of the subject systems and methods is intended to include, without being limited to, these and any other suitable types of memory.

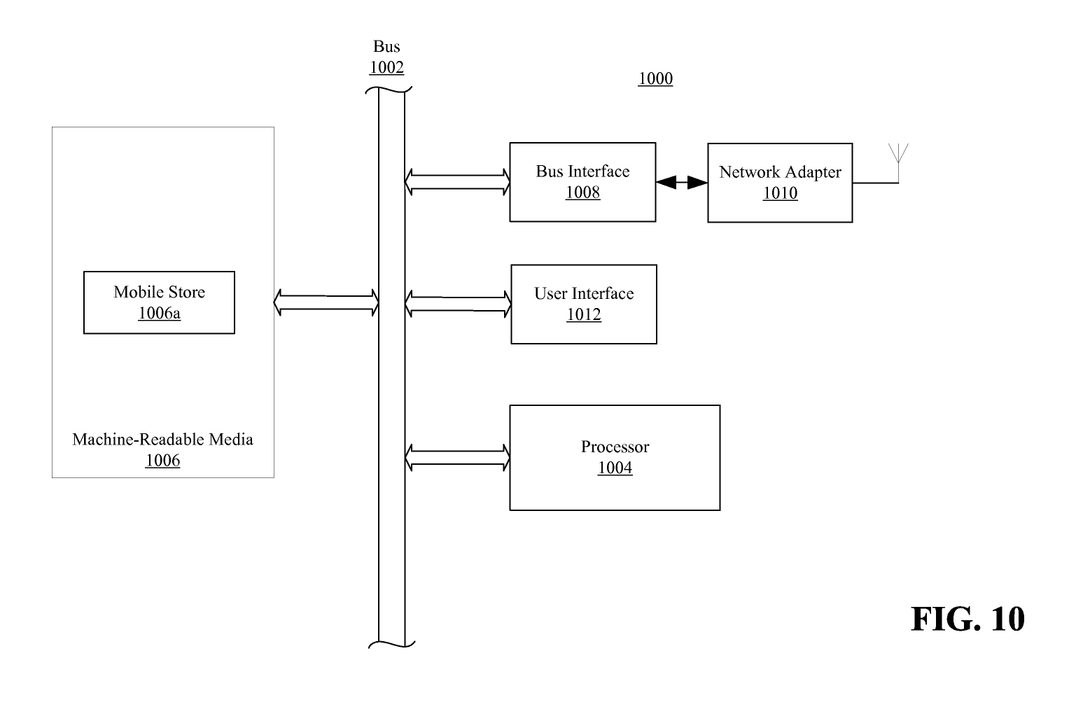

FIG. 10 illustrates a conceptual diagram illustrating an example of a hardware configuration for a processing system in a wireless node such as the wireless device that may be used to implement the system described herein. In this example, the processing system 1000 may be implemented with a bus architecture represented generally by a bus 1002. The bus 1002 may include any number of interconnecting buses and bridges depending on the specific application of the processing system 1000 and the overall design constraints. The bus links together various circuits including a processor 1004, machine-readable media 1006 and a bus interface 1008. The bus interface 1008 may be used to connect a network adapter 1010, among other things, to the processing system 1000 via the bus 1002. The network adapter 1010 may be used to implement the signal processing functions of the PHY layer. In the case of a wireless device (see FIG. 1), a user interface 1012 (e.g., keypad, display, mouse, joystick, etc.) may also be connected to the bus. The bus 1002 may also link various other circuits such as timing sources, peripherals, voltage regulators, power management circuits, and the like, which are well known in the art, and therefore, will not be described any further.

The processor 1004 is responsible for managing the bus, controlling communications, and other processing, including the execution of software stored on the machine-readable media 1006. The processor 1004 may be implemented with one or more general-purpose and/or special-purpose processors. Examples include microprocessors, microcontrollers, DSP processors and other circuitry that can execute software. Software shall be construed broadly to mean instructions, data or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof The machine-readable media may be embodied in a computer-program product. The computer-program product may comprise packaging materials.

In the hardware implementation illustrated in FIG. 10, the machine-readable media 1006 is shown as part of the processing system 1000, separate from the processor 1004. However, as those skilled in the art will readily appreciate, the machine-readable media 1006, or any portion thereof, may be external to the processing system 1000. By way of example, the machine-readable media 1006 may include a transmission line, a carrier wave modulated by data, and/or a computer product separate from the wireless node, all which may be accessed by the processor 1004 through the bus interface 1008. Alternatively, or in addition to, the machine readable media 1006, or any portion thereof, may be integrated into the processor 1004, such as the case may be with cache and/or general register files.

The processing system 1000 may be configured as a general-purpose processing system with one or more microprocessors providing the processor functionality and external memory providing at least a portion of the machine-readable media 1006, all linked together with other supporting circuitry through an external bus architecture. Alternatively, the processing system 1000 may be implemented with an ASIC (Application Specific Integrated Circuit) with the processor 1004, the bus interface 1008, the user interface 1012 in the case of an access terminal), supporting circuitry (not shown), and at least a portion of the machine-readable media 1006 integrated into a single chip, or with one or more FPGAs (Field Programmable Gate Array), PLDs (Programmable Logic Device), controllers, state machines, gated logic, discrete hardware components, or any other suitable circuitry, or any combination of circuits that can perform the various functionality described throughout this disclosure. Those skilled in the art will recognize how best to implement the described functionality for the processing system 1000 depending on the particular application and the overall design constraints imposed on the overall system.

The machine-readable media 1006 includes various modules for supporting the operation of the processing system 1000 to achieve the functionality described herein. For example, the machine-readable media 1006 may include a media store module 1006a that may implement the media store functionality in the case of the wireless device 150.

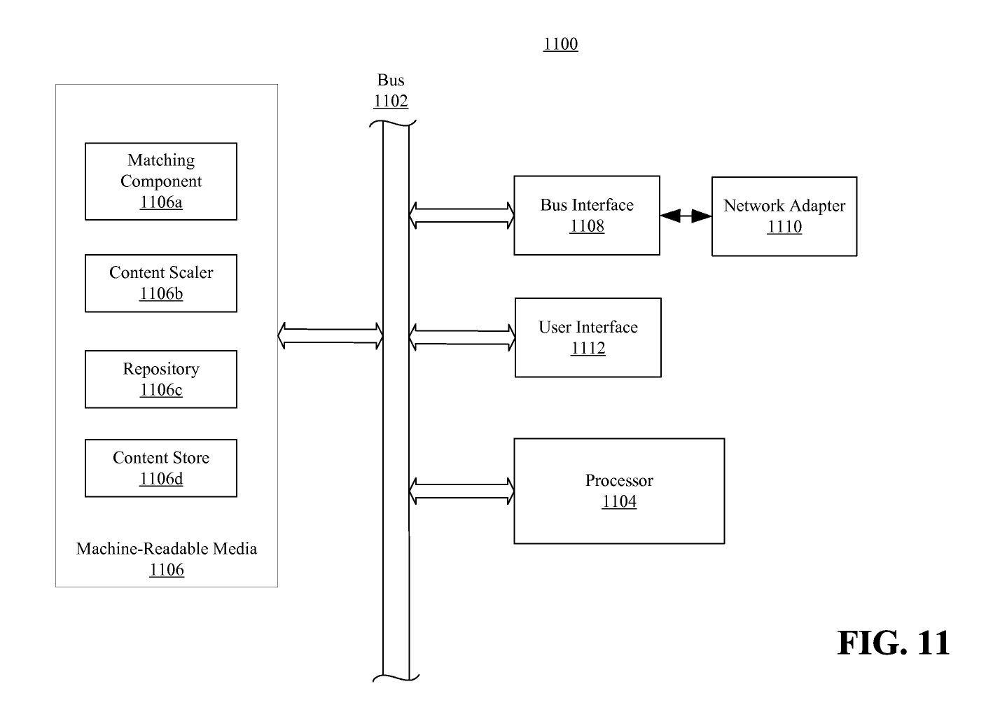

FIG. 11 illustrates a conceptual diagram illustrating an example of a hardware configuration for a processing system in a server such as the server 110 that may be used to implement the system described herein. The functionality and descriptions of the components in FIG. 10 are applicable to the same items in FIG. 11, with one difference being that the machine-readable media 1106 includes various modules for supporting the operation of the processing system 1100 to achieve the functionality described herein. Specifically, in the case of the server 110, the machine-readable media 1106 may include a matching component module 1106a, a content scaler 1106b, a repository 1106c, and a content store 1106d for performing the respective functions described above. Also, another difference is that the network adaptor 1100 may be coupled to the network using a wired interface.

It should be understood that the functionality described herein may also be implemented using a combination of hardware or software, and the functionality provided by each of the units described in the server 110, the plurality of wireless devices 150A-150C, or the wireless node 900 may be implemented in software, hardware, or a combination of both.

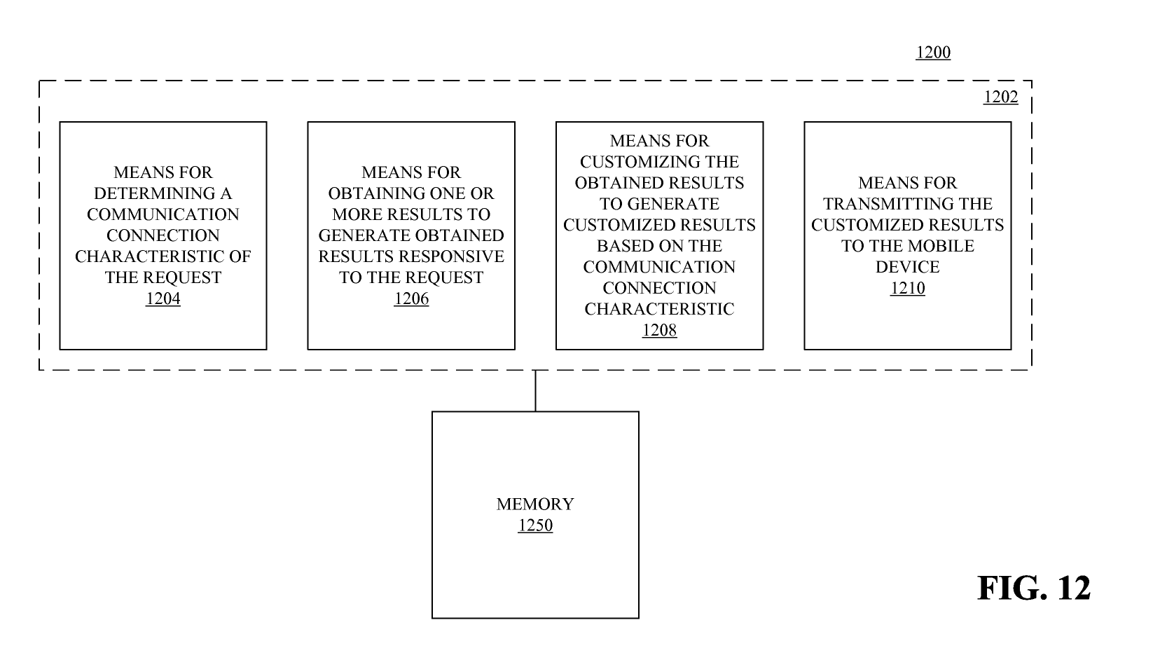

Referring to FIG. 12, an apparatus 1200 that can reside at least partially within a entity such as the server 110. It is to be appreciated that apparatus 1200 is represented as including functional blocks, which can represent functions implemented by a processor, software, or combination thereof (e.g., firmware). As such, apparatus 1200 includes a logical grouping 1202 of electrical components that can act in conjunction. For instance, logical grouping 1202 can include means for determining a communication connection characteristic of the request (Block 1204). For example, in an aspect, the means 1204 can include the matching component 1106a in FIG. 11 to receive the information from the RAN 140 in FIG. 2. Further, logical grouping 1202 can include means for obtaining one or more results to generate obtained results responsive to the request (Block 1206). For example, in an aspect, the means 1206 can include the processor 1004 retrieving information from the repository 1106c in the machine-readable media 1106 of FIG. 11. Also, logical grouping 1202 can include means for customizing the obtained results to generate customized results based on the communication connection characteristic (Block 1208). For example, in an aspect, the means 1208 can include the content scaler 1106c in the machine-readable media 1106 as executed by the processor 1104. Also, logical grouping 1202 can include means for transmitting the customized results to the mobile device (Block 1210). For example, in an aspect, the means 1210 can include a network adapter 1110 as shown in FIG. 11.

Additionally, apparatus 1200 can include a memory 1250 that retains instructions for executing functions associated with electrical components 1204, 1206, 1208 and 1210. While shown as being external to memory 1250, it is to be understood that one or more of electrical components 1204, 1206, 1208, and 1210 can exist within memory 1250. In an aspect, for example, memory 1250 may be the same as or similar to machine-readable media 1106.

It is understood that any specific order or hierarchy of steps described above is being presented to provide an example of the process involved in the preamble unit. Based upon design preferences, it is understood that the specific order or hierarchy of steps may be rearranged while remaining within the scope of the disclosed system.

Whether the above mentioned units are implemented in hardware, software, or a combination thereof will depend upon the particular application and design constraints imposed on the overall system. Skilled artisans may implement the described functionality in varying ways for each particular application, but such implementation decisions should not be interpreted as causing a departure from the scope of the disclosed system.

The previous description is provided to enable any person skilled in the art to fully understand the full scope of the disclosed system. Modifications to the various configurations disclosed herein will be readily apparent to those skilled in the art. Thus, the claims are not intended to be limited to the various aspects of the system described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for payload adaptation for a mobile device based on a request from the mobile device comprising:
determining a communication connection characteristic of the request;
obtaining one or more results to generate obtained results responsive to the request;
customizing the obtained results to generate customized results based on the communication connection characteristic; and
transmitting the customized results to the mobile device.

2. The method of claim 1, wherein the determining of the communication connection characteristic comprises at least one of:
determining the connection type of the mobile device; or
tracing a route to determine an origin of the request and associating the communication connection characteristic with the origin.

3. The method of claim 2, wherein the determining the connection type comprises:
determining the connection type of the mobile device on a radio access network; and
adding information about the connection type to the request.

4. The method of claim 2, wherein the associating the communication connection characteristic with the origin comprises:
querying for the origin; and
determining the communication connection characteristic based on the query.

5. The method of claim 4, wherein the querying for the origin comprises comparing the tracing of the route to a list of known servers.

6. The method of claim 4, wherein the tracing the route comprises determining routing information.

7. The method of claim 1, wherein the customizing the obtained results comprises at least one of:
using only a portion of the obtained results; or
altering the obtained results.

8. The method of claim 7, wherein the obtained results comprises a list of entries and the portion comprises a subset of the list of entries.

9. The method of claim 7, wherein the obtained results comprises at least an image file, an audio file, or a video file, and wherein the altering the obtained results comprises resampling the at least one image file, one audio file or one video file.

10. An apparatus for payload adaptation for a mobile device based on a request from the mobile device comprising:
means for determining a communication connection characteristic of the request;
means for obtaining one or more results to generate obtained results responsive to the request;
means for customizing the obtained results to generate customized results based on the communication connection characteristic; and
means for transmitting the customized results to the mobile device.

11. The apparatus of claim 10, wherein the means for determining the communication connection characteristic comprises at least one of:
means for determining the connection type of the mobile device; or
means for tracing a route to determine an origin of the request and associating the communication connection characteristic with the origin.

12. The apparatus of claim 11, wherein the means for associating the communication connection characteristic with the origin comprises:
means for querying for the origin; and
means for determining the communication connection characteristic based on the query.

13. The apparatus of claim 12, wherein the means for querying for the origin comprises means for comparing the tracing of the route to a list of known servers.

14. The apparatus of claim 12, wherein the means for tracing of the route comprises means for determining routing information.

15. The apparatus of claim 10, wherein the means for customizing the obtained results comprises at least one of:
means for using only a portion of the obtained results; or
means for altering the obtained results.

16. The apparatus of claim 15, wherein the obtained results comprises a list of entries and the portion comprises a subset of the list of entries.

17. The apparatus of claim 15, wherein the obtained results comprises at least an image file, an audio file, or a video file, and wherein the means for altering the obtained results comprises means for resampling the at least one image file, one audio file or one video file.

18. A computer program product for payload adaptation for a mobile device based on a request from the mobile device comprising:
a computer-readable medium comprising:
at least one instruction for causing a computer to determine a communication connection characteristic of the request;
at least one instruction for causing the computer to obtain one or more results to generate obtained results responsive to the request;
at least one instruction for causing the computer to customize the obtained results to generate customized results based on the communication connection characteristic; and
at least one instruction for causing the computer to transmit the customized results to the mobile device.

19. The computer program product of claim 18, wherein the instructions for causing the computer to determine the communication connection characteristic comprises at least one of:
at least one instruction for causing the computer to determine the connection type of the mobile device; or
at least one instruction for causing the computer to trace a route to determine an origin of the request and associating the communication connection characteristic with the origin.

20. The computer program product of claim 19, wherein the instructions for causing the computer to associate the communication connection characteristic with the origin comprises:
at least one instruction for causing the computer to query for the origin; and
at least one instruction for causing the computer to determine the communication connection characteristic based on the query.

21. The computer program product of claim 20, wherein the instructions for causing the computer to query for the origin comprises at least one instruction for causing the computer to trace the route to a list of known servers.

22. The computer program product of claim 20, wherein the instructions for causing the computer to trace the route comprises at least one instruction for causing the computer to determine routing information.

23. The computer program product of claim 18, wherein the instructions for causing the computer to customize the obtained results comprises at least one of:
at least one instruction for causing the computer to use only a portion of the obtained results; or
at least one instruction for causing the computer to alter the obtained results.

24. The computer program product of claim 23, wherein the obtained results comprises a list of entries and the portion comprises a subset of the list of entries.

25. The computer program product of claim 23, wherein the obtained results comprises at least an image file, an audio file, or a video file, and wherein the instructions for causing the computer to alter the obtained results comprises instructions for causing the computer to resample the at least one image file, one audio file or one video file.

26. An apparatus for payload adaptation for a mobile device based on a request from the mobile device comprising:
a processor; and
a memory coupled to the processor and configured to cause the processor to:
determine a communication connection characteristic of the request;
obtain one or more results to generate obtained results responsive to the request;
customize the obtained results to generate customized results based on the communication connection characteristic; and
transmit the customized results to the mobile device.

27. The apparatus of claim 26, wherein the memory is further configured to cause the processor to perform at least one of:
determine the connection type of the mobile device; or
trace a route to determine an origin of the request and associate the communication connection characteristic with the origin.

28. The apparatus of claim 27, wherein the memory is further configured to cause the processor to:
query for the origin; and
determine the communication connection characteristic based on the query.

29. The apparatus of claim 28, wherein the memory is further configured to cause the processor to compare the tracing of the route to a list of known servers.

30. The apparatus of claim 28, wherein the memory is further configured to cause the processor to determine routing information.

31. The apparatus of claim 26, wherein the memory is further configured to cause the processor to perform at least one of:
use only a portion of the obtained results; or
alter the obtained results.

32. The apparatus of claim 31, wherein the obtained results comprises a list of entries and the portion comprises a subset of the list of entries.

33. The apparatus of claim 31, wherein the obtained results comprises at least an image file, an audio file, or a video file, and wherein the memory is further configured to cause the processor to resample the at least one image file, one audio file or one video file.
